(19) United States
(12) Patent Application Publication
(10) Pub. No.: US 2026/0295622 A1
(43) Pub. Date: Oct. 1, 2026

(54) Protective Cover For Fire Sprinklers

(71) Applicant: Lisa June Touve Olsen, Las Vegas, NV (US)

(72) Inventor: Lisa June Touve Olsen, Las Vegas, NV (US)

(21) Appl. No.: 19/551,098

(22) Filed: Feb. 26, 2026

Related U.S. Application Data
(60) Provisional application No. 63/766,442, filed on Mar. 4, 2025.

(51) Int. Cl. B05B 15/16; A62C 99/00; B05C 21/00

(52) U.S. Cl. CPC B05B 15/16; B05C 21/005; A62C 99/009

(57) ABSTRACT

A protective cover for a fire sprinkler includes a flexible, elastically deformable body having an opening formed therein. The opening is elastically expandable to permit placement of the body over a fire sprinkler and elastically contracts to exert a retaining force that maintains the protective cover in engagement with the fire sprinkler or a structure associated with the fire sprinkler. The protective cover is configured to protect the fire sprinkler from paint overspray, dust, debris, and other contaminants during construction or maintenance activities. In certain embodiments, an adapter may be provided to facilitate installation on recessed sprinkler configurations, and a tool may be used to remove a sprinkler escutcheon prior to installation of the protective cover. A retention device may be used to temporarily secure the removed escutcheon during installation or maintenance.

### CROSS-REFERENCE TO RELATED APPLICATIONS

This application claims priority to U.S. Provisional Patent Application No. 63/766,442, filed on Mar. 4, 2025, the contents of which are incorporated herein by reference in their entirety.

### FIELD OF THE INVENTION

The present invention relates generally to protective covers and, more particularly, to protective covers for fire sprinklers used during construction or maintenance of a structure.

### BACKGROUND OF THE INVENTION

Fire sprinkler systems are installed in many structures to provide fire protection. During construction, tenant improvements, renovation, maintenance, repair, repainting, or other work performed in a structure, fire sprinklers may be exposed to paint overspray, dust, debris, and other contaminants. Contamination of a fire sprinkler may impair performance, interfere with mechanical operation, render the sprinkler inoperable, or necessitate replacement of the fire sprinkler to restore compliance with applicable fire protection standards.

Such contamination may result in inspection failures, violations of applicable fire protection Codes and Standards, noncompliance with regulatory requirements, or costly removal and replacement of one or more fire sprinklers. While certain surface debris such as lint or dust may in some circumstances be removed, adherent contaminants such as paint overspray may necessitate removal and replacement of affected fire sprinklers to restore compliance with applicable Codes and Standards.

In practice, trades performing work near fire sprinkler installations often attempt to protect fire sprinklers using improvised coverings such as plastic bags, tape, masking film, paper products, aluminum foil, or other temporary materials. Such coverings can loosen, tear, shift position, or permit contaminants to migrate beneath the covering. In addition, improvised coverings may permit paint overspray or debris to contact the fire sprinkler and may require additional labor for cleanup or replacement. Improvised coverings may also be inadvertently left in place after completion of work, potentially interfering with inspection or operation of the fire sprinkler. In some situations, inadequate or improperly removed coverings can result in residual contamination or obstruction that is not readily discovered.

Fire sprinklers are installed in a variety of configurations and styles, including exposed upright, exposed pendent, exposed sidewall, recessed, semi-recessed, and concealed installations. Some installations include escutcheons, cover plates, or similar components adjacent to a wall or ceiling surface. Existing improvised coverings frequently fail to provide a secure fit across these different configurations or to maintain consistent coverage when airflow, overspray, or jobsite activity occurs. Further, when an escutcheon or similar component is removed to facilitate placement of a protective covering, the component may be misplaced or damaged unless it is secured during handling and storage.

Accordingly, there is a need for improved protective solutions for fire sprinklers that can be installed and removed efficiently, that securely protect fire sprinklers from contaminants during work performed in a structure, and that accommodate different sprinkler configurations and associated components.

### SUMMARY OF THE INVENTION

The present invention provides a protective cover for a fire sprinkler that is configured to protect the fire sprinkler from paint overspray, dust, debris, and other contaminants during construction, maintenance, or other activities that create a risk of contamination. The protective cover includes a flexible, elastically deformable body and an opening formed in the body. The opening is elastically expandable to allow placement of the protective cover over at least a portion of a fire sprinkler and is configured to elastically contract to exert a retaining force that secures the protective cover on the fire sprinkler or a structure associated with the fire sprinkler.

In various embodiments, the protective cover may be formed from one or more flexible materials and may be configured to fit different fire sprinkler installation styles, including exposed, recessed, semi-recessed, and concealed fire sprinklers. The opening of the protective cover may be reinforced to improve retention and sealing around the fire sprinkler.

In some embodiments, the protective cover may be configured for reuse or disposal, depending on conditions of use. The protective cover may further include one or more adapters configured to facilitate installation on different fire sprinkler configurations, including installations where a gap exists between the fire sprinkler and a surrounding wall or ceiling surface.

In certain embodiments, a tool may be provided to facilitate removal of a sprinkler escutcheon prior to installation of the protective cover, and the escutcheon may be secured after removal to protect it from damage during storage or handling prior to reinstallation. In some implementations, the escutcheon may be secured using a retention device configured to secure the escutcheon while removed from the fire sprinkler. The invention further includes methods of protecting a fire sprinkler during construction or maintenance by installing the protective cover prior to work that creates a risk of contamination of the fire sprinkler and maintaining the protective cover in place through completion of the work.

### BRIEF DESCRIPTION OF THE DRAWINGS

The accompanying drawings illustrate exemplary embodiments of the invention and are intended to be used in conjunction with the following description.

FIG. 1 is a front view of a protective cover including a flexible body and an expandable opening.

FIG. 2 is a diagram illustrating expansion of the opening to facilitate placement of the protective cover over a fire sprinkler.

FIG. 3 is a diagram illustrating the protective cover installed on a fire sprinkler using an adapter.

FIG. 4 is a diagram illustrating the protective cover positioned over a fire sprinkler to protect the fire sprinkler from contamination.

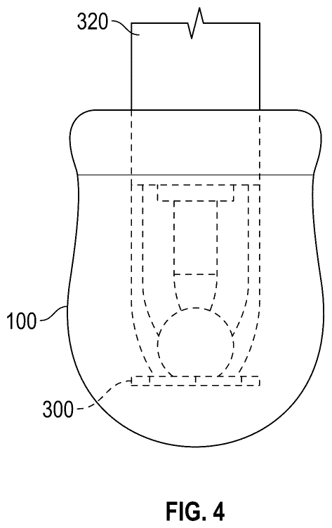

FIG. 5 is a diagram illustrating the protective cover installed over a recessed fire sprinkler using an adapter.

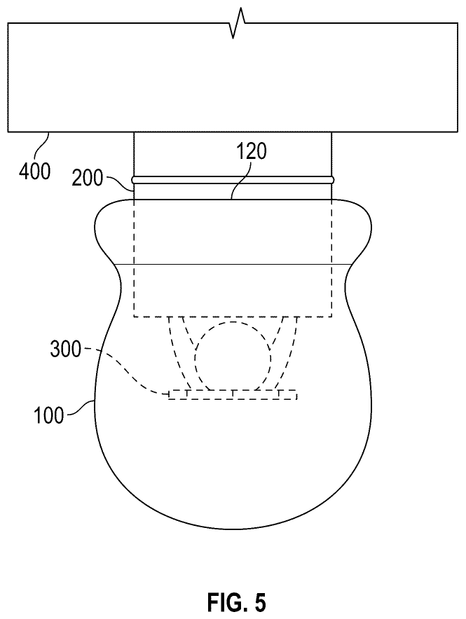

FIG. 6 is a diagram illustrating an escutcheon retention device including a plurality of compartments configured to receive one or more sprinkler escutcheons.

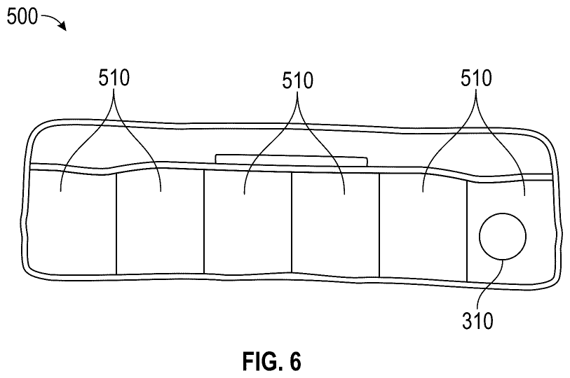

### DETAILED DESCRIPTION OF THE INVENTION

The following detailed description describes exemplary embodiments of the invention. The embodiments described are provided for illustrative purposes and are not intended to limit the scope of the invention.

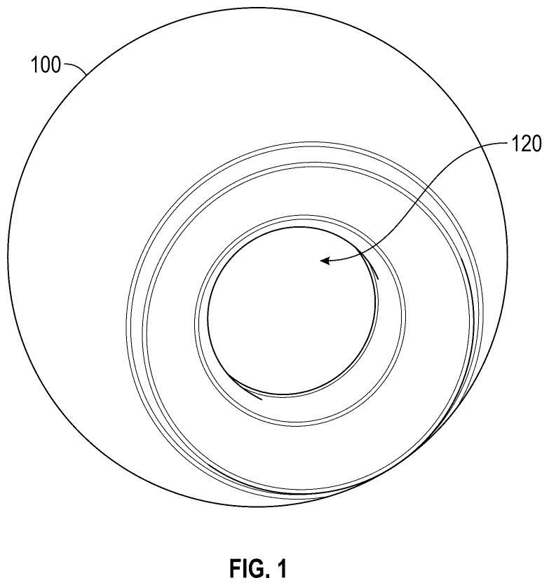

Referring to FIG. 1, a protective cover (100) includes a flexible, elastically deformable body (110) and an opening (120) formed in the body. The body (110) is configured to cover at least a portion of a fire sprinkler (300). The opening (120) is elastically expandable to allow placement of the protective cover (100) over the fire sprinkler (300) and is configured to elastically contract to exert a retaining force that maintains the protective cover (100) in engagement with the fire sprinkler (300) or a structure associated with the fire sprinkler (300). Upon placement over the fire sprinkler (300), elastic contraction of the opening (120) applies a compressive retaining force that secures the protective cover (100) in position during use.

The protective cover (100) may engage the fire sprinkler (300) itself or a structure associated with the fire sprinkler (300), including but not limited to a connected pipe (320), a protective guard or cage, an adapter (200), or surrounding installation structure. In exposed installations, the protective cover (100) may engage a portion of the pipe (320) connected to the fire sprinkler (300). In certain installations, the fire sprinkler (300) may include a protective guard or cage structure, and the flexible body of the protective cover (100) may extend over and engage such guard structures while maintaining retention. In embodiments utilizing an adapter (200), the protective cover (100) may elastically engage the adapter (200) to maintain positioning relative to the fire sprinkler (300).

The flexible body of the protective cover (100) may be formed from one or more materials capable of stretching and conforming to the exterior geometry of a fire sprinkler (300). In some embodiments, the body may comprise an elastomeric material, including but not limited to silicone. In other embodiments, the body may comprise other flexible materials suitable for conforming engagement with a fire sprinkler (300). The material may be selected to allow the protective cover (100) to be reusable or disposable depending on use conditions. In some embodiments, the flexible body may be formed as a molded, cast, extruded, or otherwise formed component. The material selection may provide varying degrees of elasticity, tear resistance, durability, chemical resistance, or temperature resistance depending on application requirements. The protective cover (100) may be formed as a unitary component or as multiple components joined together.

The opening (120) of the protective cover (100) may be reinforced to improve retention and sealing performance. Reinforcement may be achieved through increased material thickness, structural ribs, embedded bands, molded features, or other strengthening techniques. The reinforced opening (120) may enhance the ability of the protective cover (100) to remain secured to the fire sprinkler (300) or associated structure during construction or maintenance activities.

The protective cover (100) is configured to protect the fire sprinkler (300) from paint overspray, dust, debris, and other contaminants that may be present during construction or maintenance of a structure. In some embodiments, the protective cover (100) may be installed prior to commencement of work that creates a risk of contamination and may remain installed through completion of such work.

Fire sprinklers (300) may be installed in a variety of configurations, including exposed upright, exposed pendent, exposed sidewall, recessed, semi-recessed, and concealed installations. Fire sprinklers (300) may include standard-response, quick-response, early suppression fast response (ESFR), residential, or other sprinkler types and may vary in frame geometry, deflector size, and orifice diameter. The protective cover (100) may be dimensioned and elastically configured to accommodate such variations. The protective cover (100) may be configured to accommodate one or more of these installation styles. The size, geometry, and elasticity of the body and opening (120) may be selected to correspond to a particular sprinkler configuration. In exposed installations, the protective cover (100) may engage a portion of the pipe (320) connected to the fire sprinkler (300). In certain installations, the fire sprinkler (300) may include a protective guard or cage structure, and the flexible body may extend over and engage such guard structures while maintaining retention.

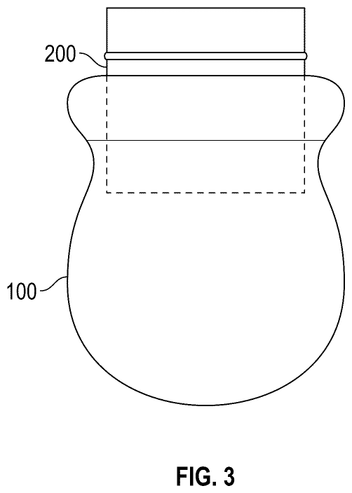

In certain embodiments, the protective cover (100) may be used in conjunction with an adapter (200), as illustrated in FIG. 3. The adapter (200) may facilitate installation of the protective cover (100) on sprinkler configurations where a gap exists between the fire sprinkler (300) and a surrounding wall or ceiling surface (400). The adapter (200) may bridge such gaps or otherwise assist in positioning or securing the protective cover (100).

In some embodiments, installation of the protective cover (100) may involve removal of a sprinkler escutcheon (310) associated with the fire sprinkler (300). A tool may be provided to facilitate removal of the escutcheon (310) prior to placement of the protective cover (100). After removal, the escutcheon (310) may be secured by a retention device (500) while the escutcheon (310) is removed from the fire sprinkler (300) during performance of work in the structure. The retention device (500) may be worn by a user, placed within a container, hung from a ladder, or otherwise temporarily secured to reduce risk of loss or damage prior to reinstallation.

In some embodiments, the retention device (500) may include a plurality of compartments (510) configured to receive one or more sprinkler escutcheons (310). The retention device (500) may further include one or more additional compartments (510) or holders configured to receive a tool used for removal of a sprinkler escutcheon (310). Such tool holder may be integrated into the retention device (500) or attached thereto and may be sized to receive a dedicated escutcheon removal tool or other accessory used during installation or removal of the protective cover (100). In certain embodiments, the tool holder may be separate from the retention device (500) and may be worn, carried, or otherwise positioned independently during performance of work. The tool holder and retention device (500) may be used together or independently, and inclusion of a tool holder is optional in any embodiment.

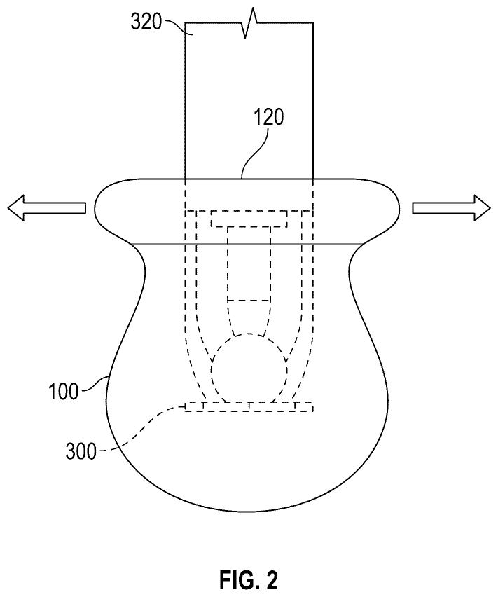

Referring to FIG. 2, a method of protecting a fire sprinkler (300) includes expanding the opening (120) of the protective cover (100), placing the protective cover (100) over at least a portion of the fire sprinkler (300), and allowing the opening (120) to elastically contract to exert a retaining force that secures the protective cover (100) on the fire sprinkler (300) or a structure associated with the fire sprinkler (300). The protective cover (100) may remain in place throughout construction or maintenance activities that create a risk of contamination of the fire sprinkler (300). The embodiments described herein are exemplary and may be modified without departing from the scope of the invention as defined by the claims.

1. A protective cover for a fire sprinkler, comprising:
a flexible, elastically deformable body configured to cover at least a portion of a fire sprinkler; and
an opening formed in the body, the opening being elastically expandable to permit placement of the body over the fire sprinkler and configured to elastically contract to exert a retaining force on the fire sprinkler or a structure associated with the fire sprinkler,
wherein the protective cover is configured to protect the fire sprinkler from paint overspray, dust, debris, or other contaminants.

2. The protective cover of claim 1, wherein the flexible, elastically deformable body comprises an elastomeric material.

3. The protective cover of claim 2, wherein the elastomeric material comprises silicone.

4. The protective cover of claim 1, wherein the opening is reinforced to increase retention of the protective cover on the fire sprinkler or a structure associated with the fire sprinkler.

5. The protective cover of claim 1, wherein the protective cover is configured to be reusable or disposable.

6. The protective cover of claim 1, wherein the protective cover is configured to fit at least one of an exposed upright fire sprinkler, an exposed pendent fire sprinkler, an exposed sidewall fire sprinkler, a recessed fire sprinkler, a semi-recessed fire sprinkler, or a concealed fire sprinkler.

7. The protective cover of claim 1, further comprising an adapter configured to facilitate installation of the protective cover on the fire sprinkler.

8. The protective cover of claim 7, wherein the adapter is configured to bridge a gap between the fire sprinkler and a surrounding wall or ceiling surface.

9. The protective cover of claim 7, further comprising a tool configured to facilitate removal of a sprinkler escutcheon to enable installation of the protective cover on the fire sprinkler using the adapter.

10. A method of protecting a fire sprinkler during construction or maintenance of a structure, comprising:
expanding an opening of a protective cover;
placing the protective cover over at least a portion of the fire sprinkler; and
allowing the opening to elastically contract to exert a retaining force that secures the protective cover on the fire sprinkler or a structure associated with the fire sprinkler,
wherein the protective cover protects the fire sprinkler from paint overspray, dust, debris, or other contaminants.

11. The method of claim 10, wherein the protective cover is installed prior to work performed in a space in which the fire sprinkler is installed that creates a risk of contamination of the fire sprinkler and remains installed through completion of the work.

12. The method of claim 10, further comprising installing an adapter to facilitate placement of the protective cover on the fire sprinkler.

13. The method of claim 12, further comprising removing a sprinkler escutcheon using a tool prior to installing the protective cover on the fire sprinkler with the adapter.

14. The method of claim 10, further comprising securing the removed sprinkler escutcheon using a retention device while the escutcheon is removed from the fire sprinkler during performance of work to reduce risk of loss or damage.

15. The method of claim 14, wherein the retention device comprises an elongated strip including a plurality of compartments configured to receive one or more sprinkler escutcheons.

16. The method of claim 14, wherein the retention device is configured to be worn by a user, placed within a container, hung from a ladder, or otherwise temporarily secured during performance of work.
